(19) United States
(12) Patent Application Publication
(10) Pub. No.: US 2021/0279378 A1
(43) Pub. Date: Sep. 9, 2021

(54) PHOTOVOLTAIC DEVICE SIMULATION METHOD AND SYSTEM, AND PROGRAM

(71) Applicant: Mun Sik KANG, Seogwipo-si (KR)

(72) Inventor: Mun Sik KANG, Seogwipo-si (KR)

(21) Appl. No.: 16/492,438

(22) PCT Filed: Jan. 15, 2019
(86) PCT No.: PCT/KR2019/000596

§ 371 Date: Sep. 9, 2019

(30) Foreign Application Priority Data
Jan. 16, 2018 (KR) 10-2018-0005329

(51) Int. Cl. G06F 30/13

(52) U.S. Cl. CPC G06F 30/13

(57) ABSTRACT

The present invention relates to a photovoltaic device simulation system for simulating an installable area of a photovoltaic device by proceeding with a simulation through real estate information, cadastral information, satellite pictures, drone images, and various pieces of sensing information of a region in which the photovoltaic device is to be provided.

### TECHNICAL FIELD

The present invention relates to a photovoltaic device simulation method and system and a program and more particularly, to a photovoltaic device simulation method and system for analyzing and simulating a place in which a photovoltaic device will be installed.

### BACKGROUND ART

With an improvement in power generation efficiency of photovoltaic devices, there is a current trend toward increasing photovoltaic devices installed at a company, a factory, a farmland, a personal building, and the like.

However, if a photovoltaic device is installed without consideration of conditions of a place in which the photovoltaic device will be installed, efficiency of the photovoltaic device may be unexpectedly degraded after the photovoltaic device is actually installed.

Meanwhile, it is not easy to measure an area in which a photovoltaic device can be installed in a building, and also it is substantially difficult to simulate a photovoltaic device using various environmental factors in addition to the available area.

The background art of the present invention is disclosed in Korean Unexamined Patent Publication No. 10-2014-0071576 and the like, but the fundamental solution to the above described problems is not proposed.

### DISCLOSURE

### Technical Problem

The present invention is directed to providing a photovoltaic device simulation method and system for calculating an available installation area on the basis of real estate information, cadastral information, and satellite photos of a region in which a photovoltaic device will be installed and a program.

Objects of the present invention are not limited to those mentioned above, and other objects which have not been mentioned will be clearly understood by those of ordinary skill in the art from the following descriptions.

### Technical Solution

One aspect of the present invention provides a photovoltaic device simulation method including receiving a land lot number of a region in which a photovoltaic device will be installed, collecting real estate information, cadastral information, and a satellite photo of a numbered land lot associated with the received land lot number, determining a land use of the numbered land lot and whether there is a building in the numbered land lot on the basis of the collected real estate information, cadastral information, and satellite photo, and calculating an available installation area of a photovoltaic device in the numbered land lot according to results of the determination.

The collecting of real estate information, cadastral information, and a satellite photo may include processing the satellite photo by detecting a boundary of an area corresponding to the land lot number in the satellite photo on the basis of the collected real estate information, cadastral information, and satellite photo.

The calculating of an available installation area may include, when there is no building in the numbered land lot, calculating an available installation area of a photovoltaic device on the basis of an area, a land use, a slope, and geographical circumstances of the numbered land lot, and the geographical circumstances may include at least one of shadow, rainfall amount information, sunlight amount information, fine dust information, daylight hours information, temperature information, climate information, and wind speed information.

The calculating of an available installation area may include, when there is a building in the numbered land lot, calculating an available installation area of a photovoltaic device in a space other than the building and on a roof of the building on the basis of a building-to-land ratio of the numbered land lot.

The method may further include storing roof data on roof shapes and installation-hindering factors in advance according to regions, building uses, and building shapes, and the calculating of an available installation area may include calculating an available installation area of a photovoltaic device by calculating a shape and an area of a roof of the building corresponding to the land lot number and a size of a hindering factor on the basis of the roof data.

The collecting of real estate information, cadastral information, and a satellite photo may include further collecting street views of a vicinity of the received land lot number, and the calculating of an available installation area may include extracting a roof image of the building from the collected satellite photo and street views, calculating a shape and an area of a roof and a size of a hindering factor through image accumulation and the extracted roof image, and calculating an available installation area of a photovoltaic device.

Another aspect of the present invention provides a photovoltaic device simulation system including an input unit configured to receive a land lot number of a region in which a photovoltaic device will be installed, a collection unit configured to collect real estate information, cadastral information, and a satellite photo of a numbered land lot associated with the land lot number received through the input unit, a determination unit configured to determine a land use of the numbered land lot and whether there is a building in the numbered land lot on the basis of the information collected through the collection unit, and a calculation unit configured to calculate an available installation area of a photovoltaic device in the numbered land lot according to determination results of the determination unit.

The collection unit may process the satellite photo by detecting a boundary of an area corresponding to the received land lot number in the satellite photo on the basis of the collected real estate information and cadastral information.

The calculation unit may calculate, when the determination unit determines that there is no building in the numbered land lot, an available installation area of a photovoltaic device on the basis of an area, a land use, a slope, and geographical circumstances of the received numbered land lot, and the geographical circumstances may include at least one of shadow, rainfall amount information, sunlight amount information, fine dust information, daylight hours information, temperature information, climate information, and wind speed information.

The calculation unit may calculate, when there is a building in the numbered land lot, an available installation area of a photovoltaic device in a space other than the building and on a roof of the building on the basis of a building-to-land ratio of the numbered land lot.

The photovoltaic device simulation system may further include a roof data module configured to store roof shapes and installation-hindering factors in advance according to regions, building uses, and building shapes, and the calculation unit may calculate an available installation area of a photovoltaic device by calculating a shape and an area of a roof of the building corresponding to the land lot number and a size of a hindering factor on the basis of information of the roof data module.

The collection unit may collect street views of a vicinity of the numbered land lot received through the input unit, and the calculation unit may extract a roof image of the building from the satellite photo and street views collected by the collection unit, calculate a shape and an area of a roof and a size of a hindering factor through image accumulation and the extracted roof image, and calculate an available installation area of a photovoltaic device.

Another aspect of the present invention provides another method and another system for implementing the present invention and a computer-readable recording medium which stores a computer program for executing the method.

### Advantageous Effects

According to the above-described present invention, it is possible to provide accurate simulation results by calculating an available installation area on the basis of real estate information, cadastral information, and a satellite photo of a place in which a photovoltaic device will be installed.

Also, according to the present invention, when there is a building in a region in which a photovoltaic device will be installed, it is possible to calculate and provide an available installation area of a photovoltaic device in a space other than the building and the roof of the building on the basis of a building-to-land ratio and roof data.

Effects of the present invention are not limited to those mentioned above, and other effects which have not been mentioned will be clearly understood by those of ordinary skill in the art from the following descriptions.

### DESCRIPTION OF DRAWINGS

FIG. 1 is a block diagram of a photovoltaic device simulation system according to an exemplary embodiment of the present invention.

FIG. 2 is a flowchart of a photovoltaic device simulation method according to an exemplary embodiment of the present invention.

FIG. 3 exemplifies a case in which there is no building in a numbered land lot according to an exemplary embodiment of the present invention, that is, no building in a numbered land lot through an actual satellite photo.

FIG. 4 exemplifies a case in which there are buildings in a numbered land lot according to an exemplary embodiment of the present invention.

FIGS. 5 and 6 exemplify a case in which there are buildings in a numbered land lot through an actual satellite photo.

FIG. 7 is a diagram illustrating a photovoltaic device simulation system employing an image captured by a drone according to an exemplary embodiment of the present invention.

FIGS. 8 to 10 exemplify a method of displaying photovoltaic device simulation results according to an exemplary embodiment of the present invention.

FIG. 11 is a diagram showing a configuration of a photovoltaic device simulator according to an exemplary embodiment of the present invention.

FIG. 12 is a view of a roof according to an exemplary embodiment of the present invention.

FIG. 13 is a view of a building according to an exemplary embodiment of the present invention.

FIG. 14 is a preview image in which solar panels are attached to a roof of a building according to an exemplary embodiment of the present invention.

FIG. 15 is a flowchart of simulation method of photovoltaic device according to an exemplary embodiment of the present invention.

### MODES OF THE INVENTION

Advantages and features of the present invention and methods for achieving them will be made clear from embodiments described below in detail with reference to the accompanying drawings. The present invention may, however, be embodied in many different forms and should not be construed as being limited to the embodiments set forth herein. Rather, these embodiments are provided so that this disclosure will be thorough and complete and will fully convey the scope of the present invention to those of ordinary skill in the art. The present invention is merely defined by the scope of the claims.

Terminology used herein is for the purpose of describing the embodiments and is not intended to be limiting to the invention. As used herein, the singular form of a word includes the plural form unless clearly indicated otherwise by context. The terms “comprises” and/or “comprising,” when used in this specification do not preclude the presence or addition of one or more elements other than the stated elements. Throughout this specification, like reference numerals refer to like elements. “And/or” includes any and all combinations of one or more of the associated elements. Although the terms “first,” “second,” etc. may be used to describe various elements, these elements are not limited by these terms. These terms are only used to distinguish one element from another element. Therefore, a first element mentioned below may be termed a second element within the technical spirit of the present invention.

Unless defined otherwise, all terms (including technical and scientific terms) used herein have the same meanings as commonly understood by those of ordinary skill in the technical field to which the present invention pertains. Terms defined in commonly used dictionaries are not to be interpreted in an idealized or overly formal sense unless explicitly so defined herein.

Hereinafter, exemplary embodiments of the present invention will be described in detail with reference to the accompanying drawings.

Before description of exemplary embodiments, terms used herein will be briefly described. However, descriptions of the terms are intended to aid in understanding this specification. Therefore, it is to be noted that the descriptions are not meant to limit the technical spirit of the present invention unless explicitly stated to be limiting to the present invention.

Street view: a street information service in which companies, such as Google, Naver, and Daum, periodically photograph streets and provide the photos to show actual views in a map together with satellite photos.

Land lot numbering: an address system, such as an address, a road-name address, and a postal code, used in different countries.

Building-to-land ratio: a ratio of building area to land area.

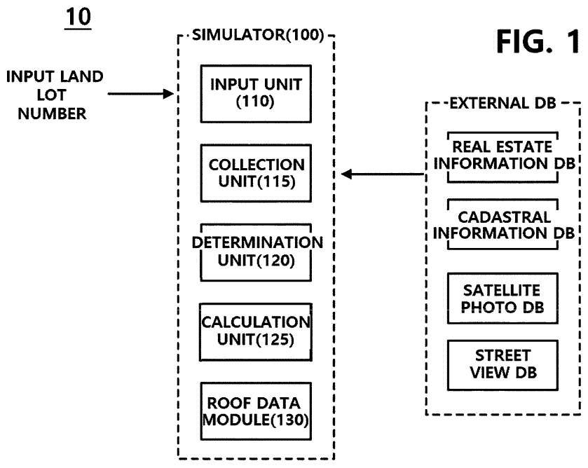

FIG. 1 is a block diagram of a photovoltaic device simulation system according to an exemplary embodiment of the present invention.

Referring to FIG. 1, a photovoltaic device simulation system 10 according to an exemplary embodiment of the present invention will be described.

A photovoltaic device simulator 100 includes an input unit 110, a collection unit 115, a determination unit 120, a calculation unit 125, and a roof data module 130.

The input unit 110 receives a land lot number of a region in which a photovoltaic device will be installed.

Preferably, the input unit 110 may receive the land lot number through a photovoltaic device simulation program provided through a user device 600.

The collection unit 115 collects real estate information, cadastral information, and a satellite photo of a numbered land lot associated with the land lot number received through the input unit 110.

The information may be loaded from a map providing service, such as Google Maps, Naver Maps, or Daum Maps, an external real-estate database (DB), and a satellite photo DB.

Then, the collection unit 115 may collect a satellite photo of a vicinity of the numbered land lot received through the input unit 110 and process the satellite photo by detecting the boundary of an area corresponding to the land lot number in the satellite photo on the basis of the real estate information and the cadastral information.

Since the satellite photo includes other surrounding buildings and regions, processing the satellite photo is for distinguishing the area corresponding to the land lot number from other regions.

Also, the collection unit 115 may collect information on geographical circumstances of the numbered land lot. The geographical circumstances are shadow, rainfall amount information, sunlight amount information, fine dust information, daylight hours information, temperature information, and wind speed information and may include factors which may have influence on photovoltaic efficiency when a photovoltaic device is installed.

Also, the collection unit 115 may collect real estate information of the numbered land lot. The real estate information may be the area of the numbered land lot, whether there is a building in the numbered land lot, the area of a building, a building-to-land ratio, the size of an outdoor parking lot, and the like.

The determination unit 120 determines a land use of the numbered land lot and whether there is a building in the numbered land lot on the basis of the information collected by the collection unit 115.

For example, the land use may be classified as farmland (paddy field, dry field, or orchard), forest land, building land (residential area, commercial area, or industrial area), or the like. It is possible to determine a land use using the real estate information or on the basis of the satellite photo using a program.

The calculation unit 125 calculates an available installation area of a photovoltaic device in the numbered land lot according to the determination results of the determination unit 120.

When the determination unit 120 determines that there is no building in the numbered land lot, the calculation unit 125 may calculate an available installation area of a photovoltaic device on the basis of the area, the land use, a slope, and geographical circumstances of the received land lot number.

At this time, it is preferable to calculate an available installation area by adding a variable of shadow to the geographical circumstances because factors, such as surrounding buildings and tress, shade (shadow) the numbered land lot and degrade efficiency of a photovoltaic device.

When the determination unit 120 determines that there is a building in the numbered land lot, the calculation unit 125 may calculate an available installation area of a photovoltaic device in a space other than the building and the roof of the building on the basis of the building-to-land ratio of the numbered land lot.

Also, the calculation unit 125 may calculate an available installation area of a photovoltaic device on the roof of a building on the basis of roof shapes and installation-hindering factors according to regions, building uses, and building shapes. At this time, the calculation unit 125 may load information on roofs using TensorFlow (Google artificial intelligence (AI)) or calculate information on roofs using a program DB which has been built for the calculation unit 125.

As an example, instead of using such external information, the photovoltaic device simulation system 10 may further include a roof data module 130.

The roof data module 130 stores roof shapes and installation-hindering factors according to regions, building uses, and building shapes. Installation-hindering factors indicate factors that hinder a photovoltaic device from being installed on a roof. For example, an outdoor fan, a water tank, etc. may be such installation-hindering factors.

The calculation unit 125 may calculate an available installation area of a photovoltaic device by calculating the shape and the area of the roof of the building corresponding to the numbered land lot and the size of a hindering factor on the basis of information of the roof data module 130.

As a second example, the collection unit 115 may collect street views of a vicinity of the numbered land lot received through the input unit 110. Then, the calculation unit 125 may extract a roof image of the building from the satellite photo and the street views collected through the collection unit 115 and calculate an installation available area of a photovoltaic device by calculating the shape and the area of the roof and the size of a hindering factor through image accumulation and the extracted roof image.

The calculation unit 125 may calculate an available installation area by excluding the size of a hindering factor from the total area of the roof.

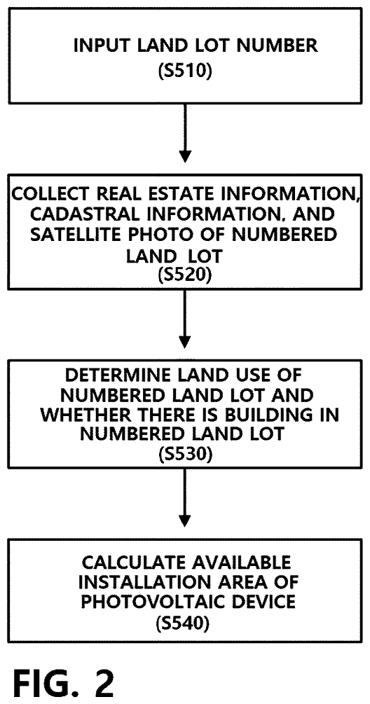

FIG. 2 is a flowchart of a photovoltaic device simulation method according to an exemplary embodiment of the present invention.

Referring to FIG. 2, a sequence of a photovoltaic device simulation method according to an exemplary embodiment of the present invention will be described.

The input unit 110 receives a land lot number of a region in which a photovoltaic device will be installed (step S510).

Subsequently, the collection unit 115 collects real estate information, cadastral information, and a satellite photo of a numbered land lot associated with the land lot number received through the input unit 110 (step S520).

The simulation method may further include a step in which the collection unit 115 collects a satellite photo of a vicinity of the numbered land lot received through the input unit 110 and processes the satellite photo by detecting the boundary of an area corresponding to the land lot number on the basis of the real estate information and the cadastral information.

Subsequently, the determination unit 120 determines a land use of the numbered land lot and whether there is a building in the numbered land lot on the basis of the real estate information, cadastral information, and satellite photo collected through the collection unit 115 (step S530).

Subsequently, the calculation unit 125 calculates an available installation area of a photovoltaic device in the numbered land lot according to determination results of the determination unit 120 (step S540).

Step S540 may branch into a case in which there is no building in the numbered land lot and a case in which there is a building in the numbered land lot.

In other words, when there is no building in the numbered land lot, the calculation unit 125 calculates an available installation area of a photovoltaic device using an area, a land use, a slope, and geographical circumstances of the numbered land lot (step S550).

The geographical circumstances may include at least one of shadow, rainfall amount information, sunlight amount information, fine dust information, daylight hours information, temperature information, climate information, and wind speed information.

When there is a building in the numbered land lot, the calculation unit 125 calculates an available installation area of a photovoltaic device in a space other than the building and the roof of the building using the building-to-land ratio of the numbered land lot (step S560).

More specifically, the simulator 100 according to the present invention may further include a roof data module 130 in which roof shapes and installation-hindering factors are stored in advance according to regions, building uses, and building shapes. In this case, the calculation unit 125 may calculate an available installation area of a photovoltaic device by calculating the shape and the area of the roof of the building corresponding to the land lot number and the size of a hindering factor on the basis of information of the roof data module 130.

As another example, the collection unit 115 may collect street views of a vicinity of the numbered land lot received through the input unit 110. Then, the calculation unit 125 may extract a roof image of the building from the satellite photo and the street views collected through the collection unit 115. Also, the calculation unit 125 may calculate an installation available area of a photovoltaic device by calculating the shape and the area of the roof and the size of a hindering factor through image accumulation and the extracted roof image.

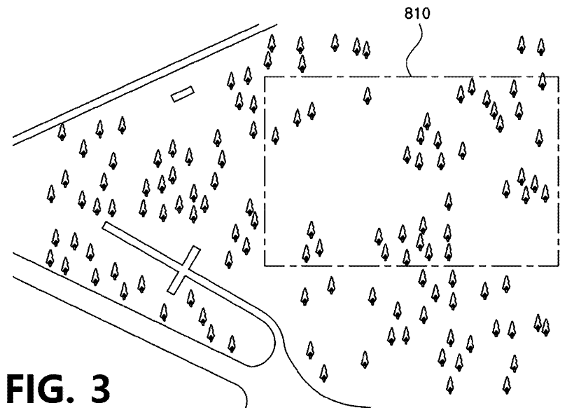

FIG. 3 exemplifies a case in which there is no building in a numbered land lot through an actual satellite photo.

In other words, FIG. 3 exemplifies a satellite photo of a corresponding numbered land lot collected by the collection unit 115 after a land lot number of 810 is input through the input unit 110.

In this case, since there is no building in the land lot numbered 810, the calculation unit 125 may calculate an available installation area of a photovoltaic device using an area, a land use, a slope, and geographical circumstances of the numbered land lot.

For example, referring to the satellite photo of FIG. 3, a large number of trees are present in the land lot numbered 810. Therefore, the calculation unit 125 may calculate an available installation area of a photovoltaic device by excluding areas of the trees and shadows of the trees.

The simulator 100 according to an exemplary embodiment of the present invention may provide a natural environment setting mode.

When it is selected through the input unit 110 to perform simulation with the natural environment being maintained, the simulator 100 calculates an area in which a photovoltaic device can be installed with the natural environment, such as trees, being maintained.

On the other hand, when it is selected through the input unit 110 to ignore the natural environment and perform simulation, the simulator 100 assumes that there is no natural environment, such as trees, in the location and calculates an available installation area of a photovoltaic device with the natural environment excluded.

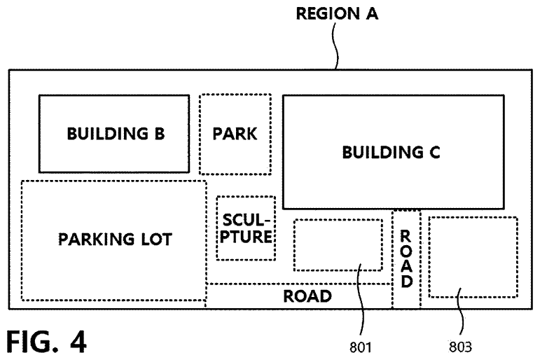

FIG. 4 exemplifies a case in which there are buildings in a numbered land lot according to an exemplary embodiment of the present invention.

In other words, FIG. 4 exemplifies information on a region A collected and displayed by the collection unit 115 after a land lot number of the region A is input through the input unit 110.

There are B building and C building in the region A, and the building-to-land ratio is relatively low. Actually, however, a parking lot is large, and there is a park and sculpture. Therefore, spaces 801 and 803 in which a photovoltaic device can be practically installed are obtained by excluding the areas of the parking lot, park, sculpture, and road from the total area of the region A, and rooftops of building B and building C may also be available installation spaces.

The simulator 100 according to an exemplary embodiment of the present invention has a function for recognizing a park, a parking lot, sculpture, and a road in a satellite photo, such as FIG. 4, and filtering them.

Therefore, the simulator 100 may exclude a place (area) in which a photovoltaic device cannot be installed from a satellite photo through filtering and perform simulation on the basis of available installation places.

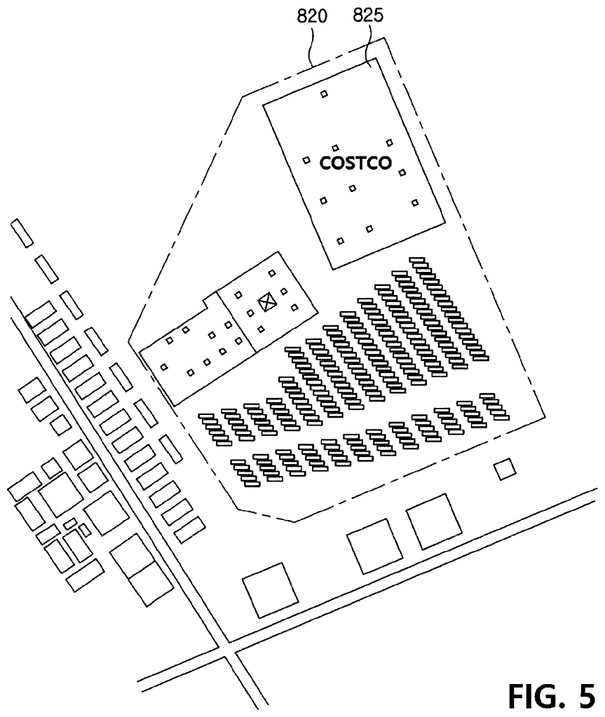

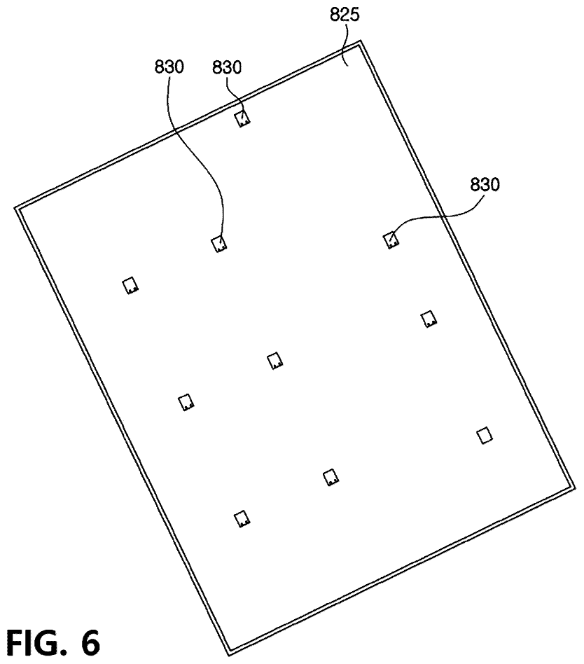

FIGS. 5 and 6 are exemplary diagrams of a case in which there are buildings in a numbered land lot through an actual satellite photo.

FIGS. 5 and 6 exemplify a satellite photo of a Costco store in a specific region using Google Maps.

When the land lot number of a Costco store is input through the input unit 110, the collection unit 115 collects a satellite photo including a vicinity of the Costco store as shown in FIG. 5. Also, the collection unit 115 processes the satellite photo by detecting the boundary of an area corresponding to the land lot number of the Costco store as an area 820 using real estate information and cadastral information.

Then, the calculation unit 125 calculates an available installation area of a photovoltaic device in a space other than buildings and the roofs of the buildings using the processed satellite photo and the building-to-land ratio of the numbered land lot.

In the area 820, there is the Costco store and two buildings. Since the area 820 other than the Costco store and the two building is used as a parking lot, the building-to-land ratio is relatively low. In fact, however, a photovoltaic device can be installed on the roofs of the Costco store and the two buildings. Since it is assumed that no photovoltaic device can be installed in a parking lot, a case of installing a photovoltaic device in a parking lot is considered an exception.

FIG. 6 exemplifies an enlarged area of a roof 825 of the Costco store.

Referring to FIG. 6, multiple hindering factors (outdoor fans, water tanks, etc.) 830 are installed. Therefore, the calculation unit 125 may calculate an available installation area of a photovoltaic device by excluding the sizes of the hindering factors from the total area of the roof.

More specifically, the simulator 100 according to an exemplary embodiment of the present invention may recognize installation-hindering factors in the satellite photo and perform simulation of photovoltaic device installation in consideration of the installation-hindering factors.

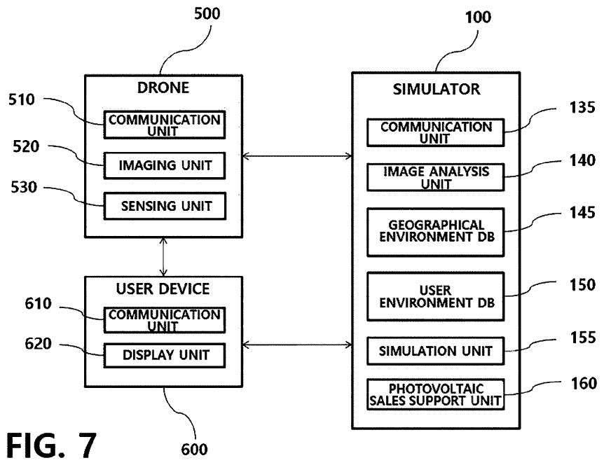

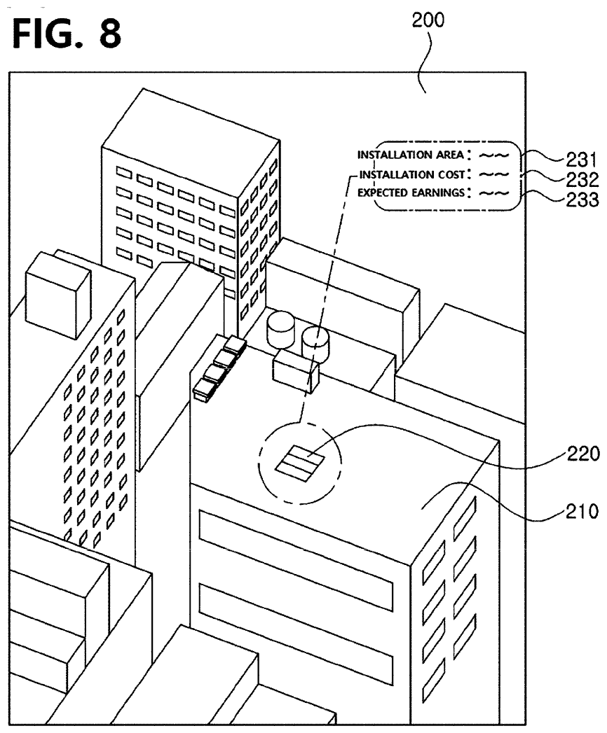

FIG. 7 is a diagram illustrating a photovoltaic device simulation system 10 employing an image captured by a drone 500 according to an exemplary embodiment of the present invention, and FIGS. 8 to 10 exemplify a method of displaying photovoltaic device simulation results according to an exemplary embodiment of the present invention.

While FIGS. 1 to 6 exemplify simulation performed by receiving a land lot number and collecting real estate information, cadastral information, and a satellite photo on the basis of the land lot number, FIGS. 7 to 10 exemplify simulation performed using the drone 500.

In other words, according to the present invention, it is possible to perform simulation by receiving a land lot number or using the drone 500, or it is possible to perform simulation of photovoltaic device installation more accurately using both of the two methods.

Referring to FIG. 7, the photovoltaic device simulation system 10 according to an exemplary embodiment of the present invention includes the drone 500, a simulator 100, and a user device 600.

The drone 500 includes a communication unit 510, an imaging unit 520, and a sensing unit 530.

The simulator 100 includes a communication unit 135, an image analysis unit 140, a geographical environment DB 145, a user environment DB 150, a simulation unit 155, and a photovoltaic sales support unit 160.

The user device 600 includes a communication unit 610 and a display unit 620, and each of the drone 500, the simulator 100, and the user device 600 may include a control unit 170.

According to an exemplary embodiment of the present invention, each constituent module included in the drone 500, the simulator 100, and the user device 600 may be omitted or implemented to be included in any one constituent module.

Also, according to an exemplary embodiment, one or more constituent modules included in the simulator 100 may be implemented in the drone 500 or the user device 600. This will be described below again.

The drone 500 may be a concept including an unmanned airplane having a photography function, an unmanned aerial imaging device, and the like. Flight and photography of the drone 500 may be controlled through a remote controller or the user device 600.

The communication unit 510 of the drone 500 makes wireless communication possible and may exchange data with an external device or an external server. The communication unit 510 may transmit a drone image captured by the imaging unit to the external device or the external server or receive a control signal or data from the external device or the external server.

The imaging unit 520 of the drone 500 is configured to include a camera and may capture an external image during flight of the drone 500. In this exemplary embodiment, the imaging unit 520 may capture images corresponding to a building in which a photovoltaic device will be installed and a vicinity of the building.

The sensing unit 530 of the drone 500 may include one or more sensors which can sense surroundings of the drone 500. For example, the sensing unit 530 may include at least one of a flight altitude measuring sensor capable of sensing the flight altitude of the drone 500, a solar elevation angle measuring sensor capable of measuring a current elevation angle of the sun, a laser sensor capable of measuring a distance to a surrounding element, an altitude difference with a surrounding element, etc., and an ultrasonic sensor.

While capturing a drone image through the imaging unit 520 of the drone 500, the drone 500 may sense surroundings thereof through the sensing unit 530 and store sensing results.

The simulator 100 may be an element which analyzes the drone image captured by the drone 500, environmental circumstances of a region in which a photovoltaic device will be installed, and environmental circumstances of a user together and simulates an optimal installation location of a photovoltaic device and effects resulting from the installation.

The communication unit 135 of the simulator 100 may exchange data with the drone 500 and the user device 600 through wireless communication. The communication unit 135 may receive the drone image from the drone 500. Also, the communication unit 135 may receive the sensing results of the sensing unit from the drone 500. The communication unit 135 may receive a user's environmental circumstances, such as electricity bills, time-specific power usages, a lifestyle, and electric power company information, from the user device 600.

The image analysis unit 140 may analyze the drone image on the basis of the drone image and sensing results received from the drone 500. Specifically, the image analysis unit 140 may analyze the shape and height of a building in which a photovoltaic device will be installed, exterior views (shapes, heights, etc.) of buildings around the building, a change of the shadow caused by the sun, etc. on the basis of the drone image and analyze a change in the amount of sunlight, shading, etc. over time on the basis of the received sensing results.

The geographic environment DB 145 may store geographical circumstances of a region in which a photovoltaic device will be installed and neighboring regions. The geographical environment DB 145 may be built and updated on the basis of information received from the user device 600 and/or information received from an external organization (e.g., the Korea Meteorological Administration, an electric power company, etc.). Information stored in the geographical environment DB 145 may include at least one of rainfall amount information, sunlight amount information, fine dust information, daylight hours information, temperature information, climate information, and wind speed information.

The user environment DB 150 may store circumstances of a user who wants to install a photovoltaic device. The user environment DB 150 may be built and updated on the basis of information received from the user device 600 and/or information received from an external organization (e.g., an electric power company, a heating service provider, etc.). Information stored in the user environment DB 150 may include at least one of electricity bills, time-specific power usages, a lifestyle, and electric power company information.

At least one of the geographical environment DB 145 and the user environment DB 150 may not be provided according to embodiments.

The simulation unit 155 may simulate an optimal installation location in a building in which a photovoltaic device will be installed, an optical installation area, cost for installation, and installation effects on the basis of analysis results of the image analysis unit 140 and information stored in the geographical environment DB 145 and the user environment DB 150.

As an example, the simulation unit 155 may calculate a desired amount of photovoltaic power generation on the basis of information stored in the geographical environment DB 145 and the user environment DB 150, find an installation area and an installation location of a photovoltaic device required for achieving the calculated amount of photovoltaic power generation on the basis of analysis results of the image analysis unit 140, and calculate an installation cost for a photovoltaic device and earnings from the installation according to photovoltaic device manufacturers.

As another example, the simulation unit 155 may find an area and location in which a photovoltaic device can be installed on the basis of analysis results of the image analysis unit 140, calculate whether it is possible to generate the desired amount of photovoltaic power generation in the found installation area and location on the basis of information stored in the geographical environment DB 145 and the user environment DB 150, and calculate a resultant installation cost for a photovoltaic device and earnings from the installation according to photovoltaic device manufacturers.

The simulation unit 155 may select a photovoltaic device manufacturer preferred by a user or a photovoltaic device manufacturer that is used most frequently with priority and calculate the installation cost.

The photovoltaic sales support unit 160 may support brokerage between a relevant photovoltaic device installation service provider, management service provider, or seller and a user.

The simulator 100 may transmit simulation results to the communication unit 610 of the user device through the communication unit 135.

The user may obtain the simulation results through the display unit 620 of the user device 600. According to embodiments, a manager of the simulator 100 may develop and manage a photovoltaic device simulation application employing the drone 500, and the user may obtain the simulation results through the application installed on the user device 600.

FIG. 7 shows the drone 500 and the simulator 100 as separate elements. According to embodiments, however, when the drone 500 is a high-end drone, at least one of the image analysis unit 140, the geographical environment DB 145, the user environment DB 150, and the simulation unit 155 may be directly implemented in the drone 500. When the simulation unit 155 is implemented in the drone 500, a user may obtain simulation results through a display unit (not shown) provided in the drone 500 or simulation results transmitted from the drone 500 to the user device 600.

According to embodiments, at least one of the image analysis unit 140, the geographical environment DB 145, the user environment DB 150, and the simulation unit 155 may be directly implemented in the user device 600. In this case, the user device 600 may receive a drone image directly from the drone 500.

Referring to FIG. 8, simulation results derived by the simulation unit 155 of the simulator 100 are displayed. The simulation results may be displayed by the display unit of the user device 600 or the display unit (not shown) provided in the drone 500.

In this exemplary embodiment, a case in which simulation results are displayed through an execution screen 200 of the photovoltaic device simulation application installed on the user device 600 will be described as an example. The execution screen 200 of the photovoltaic device simulation application may show simulation results in a satellite photo or a three-dimensional (3D) satellite photo corresponding to a building 210 in which a photovoltaic device will be installed. The simulation results may include an optimal installation location 220, an installation area or the number of installed photovoltaic devices 231, an installation cost 232, expected earnings 233, etc. of photovoltaic devices in a building rooftop.

A user may check a location at which a photovoltaic device is installed and effects resulting from the installation in advance through the simulation results shown in the execution screen of the photovoltaic device simulation application.

Also, referring to FIG. 8, there are hindering factors, such as outdoor fans, pipes, and water tanks, are in the rooftop of the building 210. Therefore, the simulator 100 may perform simulation by recognizing the area of the building rooftop and the hindering factors and then may calculate an installation area, an installation cost, and expected earnings.

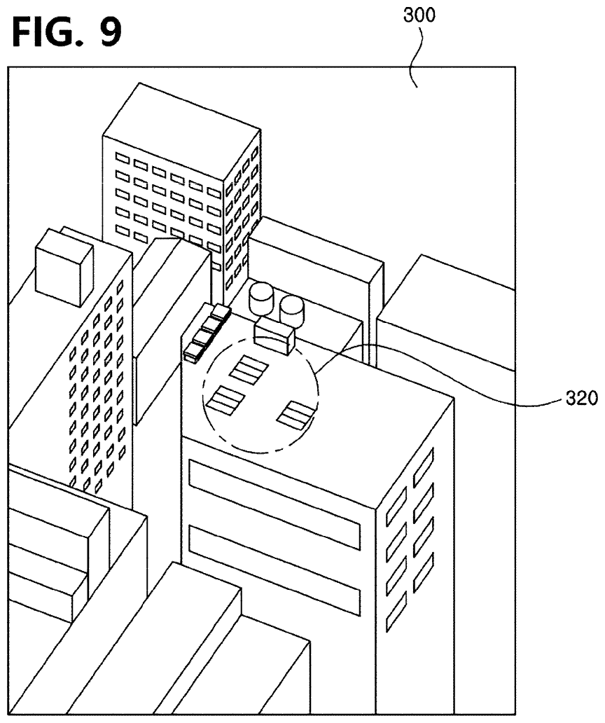

Referring to FIG. 9, simulation results are displayed through an execution screen 300 of the photovoltaic device simulation application. The execution screen 300 of the photovoltaic device simulation application may display 320 candidate installation locations which are appropriate for photovoltaic device installation in order of priority. Priority orders may be determined on the basis of preference input by a user (e.g., a user who wants to minimize installation cost or a user who wants to maximize expected earnings). A user may select any one of the three candidate installation locations and obtain information as shown in FIG. 8, such as an installation area or the number of installed photovoltaic devices, an installation cost, and expected earnings.

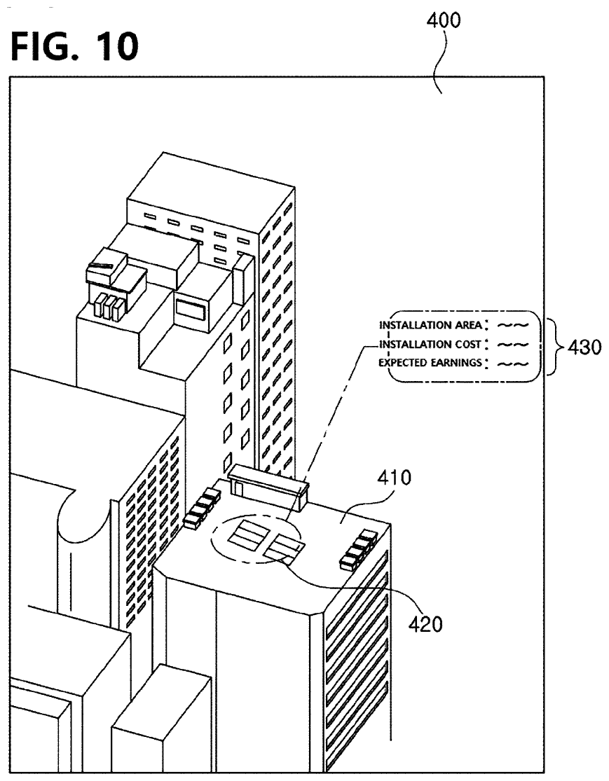

Referring to FIG. 10, simulation results are displayed through an execution screen 400 of the photovoltaic device simulation application. The execution screen of the photovoltaic device simulation application may include photovoltaic device icons corresponding to a location 420, which is calculated as an optimal installation location through simulation, on a rooftop 410 of a building in which a photovoltaic device is installed and detailed information 430 resulting from the installation of a photovoltaic device. However, according to a user's personal circumstances, he or she may want to modify simulation results and install a photovoltaic device. Therefore, according to this exemplary embodiment, a user may move the location of a photovoltaic device icon on a building or change the size of a photovoltaic device icon (corresponding to an actual installation area). When a user touches and moves the icon, it is possible to change (re-calculate) and display detailed information according to the corresponding location. Also, when a user changes the size of the icon by making a multi-touch input, it is possible to change and display detailed information according to the changed size.

According to the above-described exemplary embodiments of the present invention, simulation results are provided as if a user installed a photovoltaic device in an actual building so that the user may experience an optimal installation location and effects resulting from the installation.

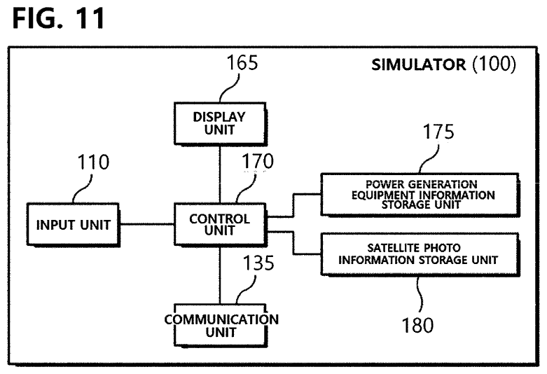

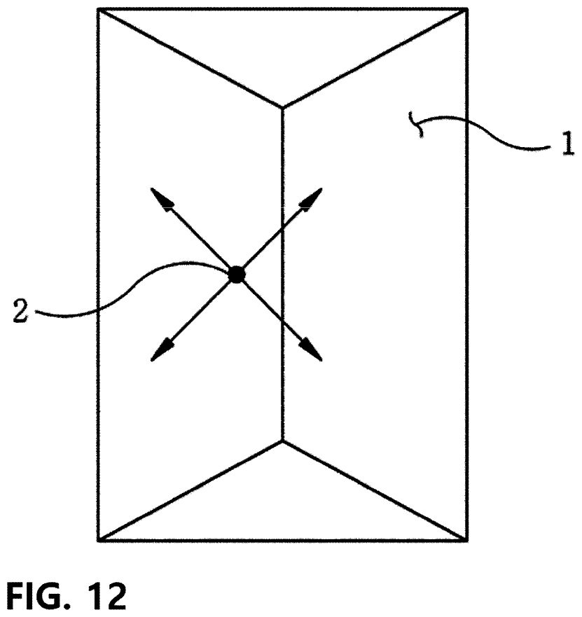

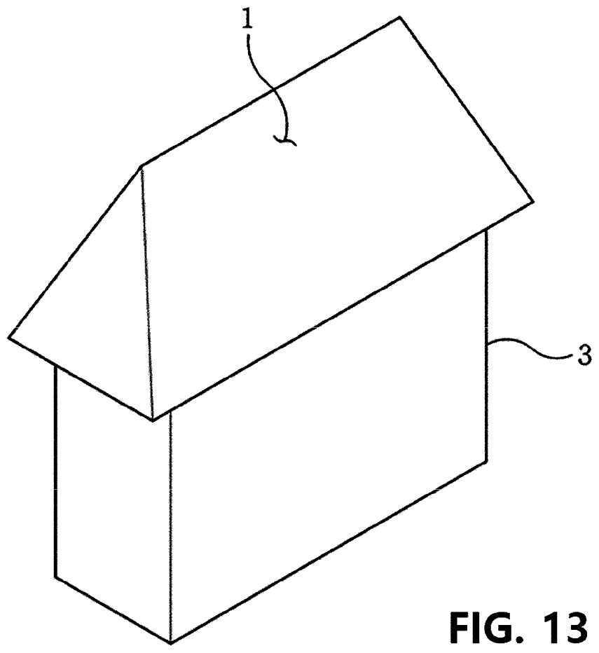

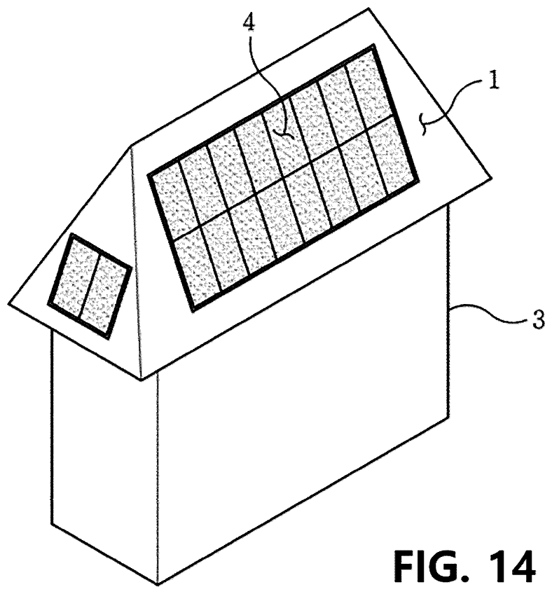

FIG. 11 is a diagram showing a configuration of a photovoltaic device simulator 100 according to an exemplary embodiment of the present invention, and FIG. 12 is a view of a roof according to an exemplary embodiment of the present invention. Also, FIG. 13 is a view of a building according to an exemplary embodiment of the present invention, and FIG. 14 is a preview image in which solar panels are attached to the roof of a building according to an exemplary embodiment of the present invention.

Referring to FIGS. 11 to 14, the photovoltaic device simulator 100 of the present invention may be configured to include an input unit 110, a display unit 165, a power generation equipment information storage unit 175, a satellite photo information storage unit 180, a communication unit 135, and a control unit 170.

While block diagrams of a simulation system are shown in FIGS. 1 and 7, a block diagram of a simulator is shown in FIG. 11. However, these are merely classified for description of exemplary embodiments and may be mixed according to embodiments of the present invention.

The input unit 110 is an element for information input. The input unit 110 includes a keyboard, a keypad, a touchpad, a touch screen, and the like. The input unit 110 transfers a signal according to input information to the control unit 170.

The display unit 165 is an element for information display. The display unit 165 includes a screen for visually displaying information. The display unit 165 displays various kinds of information under the control of the control unit 170 such that a user may obtain the information.

The power generation equipment information storage unit 175 is a storage in which various kinds of information on power generation equipment employing solar panels 4 is stored. The power generation equipment information storage unit 175 stores various kinds of information related to elements included in photovoltaic power generation equipment, a required installation area, an installation cost, and a power generation capacity, such as the size, power generation capacity, and price of the solar panels 4, the size and price of an auxiliary installation, and a service charge for installation of the photovoltaic power generation equipment and includes a memory for the purpose. The various kinds of information stored in the power generation equipment information storage unit 175 may be received by the control unit 170 from an external device through the communication unit 135 and stored.

The satellite photo information storage unit 180 is a storage in which photo information captured by a satellite is stored. The satellite photo information storage unit 180 may store satellite photos of locations specified with the latitude and longitude or the address and further store satellite photos obtained by enlarging specific locations. The satellite photo information storage unit 180 includes a memory for the purpose. Satellite photos stored in the satellite photo information storage unit 180 may be satellite photos which are received from an external device through the communication unit 135 and stored by the control unit 170.

The communication unit 135 is an element for information exchange. The communication unit 135 includes various communication interfaces for transmitting and receiving data via a communication network.

The control unit 170 serves to control overall operation of the photovoltaic device simulator 100 including the input unit 110, the display unit 165, the power generation equipment information storage unit 175, the satellite photo information storage unit 180, and the communication unit 135. The control unit 170 includes a calculation unit, a memory, a program storage, etc. for the purpose.

First, the control unit 170 receives information on an installation location from a user who wants to install photovoltaic power generation equipment through the input unit 110. At this time, the control unit 170 may receive an address of a building 3 in which photovoltaic power generation equipment will be installed through the input unit 110, and the location information may be input in the form of text or voice. When location information is input through the input unit 110 in the form of voice, the control unit 170 may convert the location information into text which indicates a location using voice recognition.

Then, the control unit 170 retrieves a satellite photo of the building 3 corresponding to the location information input through the input unit 110 from satellite photo information stored in the satellite photo information storage unit 180. Satellite photos stored in the satellite photo information storage unit 180 may be information which has been stored in advance under the control of the control unit 170. Meanwhile, the control unit 170 may request a satellite photo of the building 3 corresponding to the location information from an external device, which provides satellite photos, through the communication unit 135 according to the location information input through the input unit 110 and receive the satellite photo. In this case, the device which provides satellite photos may be a device that a manager of the photovoltaic device simulator 100 has or a device of a service provider which provides satellite photos for free or according to a contract.

After retrieving the satellite photo of the building 3 corresponding to the location information input through the input unit 110, the control unit 170 settles the boundary of a location in which the solar panels 4 can be installed in the satellite photo of the building 3 and calculates the area of the installation location specified by the settled boundary.

At this time, the control unit 170 may designate a point 2 on the satellite photo of the building 3 corresponding to the location information input through the input unit 110 and detect the boundary by expanding the area to pixels which have pixel values within a predetermined range from the pixel value of the pixel corresponding to the designated point 2 on the basis of the location of the pixel corresponding to the designated point 2.

In this regard, referring to FIG. 12, a roof 1 of the building 3 corresponding to the location information input through the input unit 110 is shown, and the control unit 170 designates the point 2 corresponding to the location information. Then, the control unit 170 checks whether a pixel has a pixel value within the predetermined range from the pixel value of the pixel corresponding to the designated point 2 while gradually expanding the area to adjacent pixels on the basis of the location of the pixel corresponding to the designated point 2. When a pixel has a similar pixel value within the predetermined range from the pixel value of the pixel corresponding to the designated point 2, the control unit 170 determines that the pixel corresponds to the roof 1 and expands the area by repeating a process of comparing the pixel value of another adjacent pixel with the pixel value of the pixel corresponding to the designated point 2. On the contrary, when a pixel has a pixel value exceeding the predetermined range from the pixel value of the pixel corresponding to the designated point 2, the control unit 170 may determine that the pixel corresponds to a part other than the roof 1 and detect the boundary of the roof 1 on the basis of the edge of pixels which have been hitherto determined to correspond to the roof 1.

Meanwhile, since a satellite photo of the building 3 is in a two-dimensional (2D) form, the control unit 170 may determine the 3D shape of the building 3 by fusing a satellite photo of the building and a road view image of the building 3 and calculate the area of a location in which the solar panels 4 can be installed. The road view image may be information stored in an internal storage of the control unit 170 or information that the control unit 170 requests and receives from an external device through the communication unit 135 as necessary.

In this regard, FIG. 13 shows a road view image of the building 3, and the control unit 170 may calculate a coordinate conversion matrix between the satellite photo of the building 3 and the road view image of the building 3 by matching feature points, which are extracted from the satellite photo which shows only the roof 1 of the building 3 as shown in FIG. 12 and feature points extracted from the road view image of the building 3 as shown in FIG. 13, to each other. Then, the control unit 170 may fuse the satellite photo of the building 3 and the road view image of the building 3 into a 3D form using the coordinate conversion matrix. On the basis of the 3D image, the control unit 170 may find the 3D shape of the roof 1 to which the solar panels 4 will be attached and calculate the area of a location in which the solar panels 4 can be installed.

Subsequently, the control unit 170 calculates the number of solar panels 4 that can be installed on the building 3 by referring to a required installation area for a solar panel 4 stored in the power generation equipment information storage unit 175 according to the calculated area.

Then, the control unit 170 visually displays information on installation cost for photovoltaic power generation equipment according to the number of solar panels 4 that can be installed on the building 3 and information on the amount of electric power that can be generated through photovoltaic power generation on the screen of the display unit 165 such that a user can obtain the information.

At this time, as shown in FIG. 14, the control unit 170 may display the building 3 on which solar panels 4 are installed on the screen of the display unit 165 as a preview, and a user can intuitively understand the appearance of the building 3 on which solar panels 4 are installed.

Meanwhile, when there is a shaded part in the satellite photo of the building 3 or the road view image of the building 3, it is possible to provide results close to the actual amount of generated power by subtracting the amount of generated power corresponding to the shaded part from a total amount of generated power. In this case, the control unit 170 may determine a part having pixel values corresponding to a darker color than other pixels within the boundary of the location in which the solar panels 4 can be installed as a shaded part. When the satellite photo of the building 3 and the road view image of the building 3 may be fused together to find the 3D shape, pixel values of identical points between parts of the two images in which the solar panels 4 can be installed may have a difference of a predetermined value or more. In this case, the point may be determined as a shaded part.

Also, the control unit 170 may calculate expected earnings from photovoltaic power generation by referring to the transaction cost of an electric power exchange corresponding to the location information of the building 3 and display the expected earnings on the screen of the display unit 165. In this case, the control unit 170 may request and receive cost related to the transaction cost of the electric power exchange from an external device through the communication unit 135 using the location information of the building 3. The control unit 170 may calculate the surplus amount of generated power by excluding the amount of power used in the building 3 from the total amount of generated power based on the power generation capacity of the solar panels 4 and then calculate expected earnings by applying the transaction cost of the electric power exchange to the surplus amount of generated power.

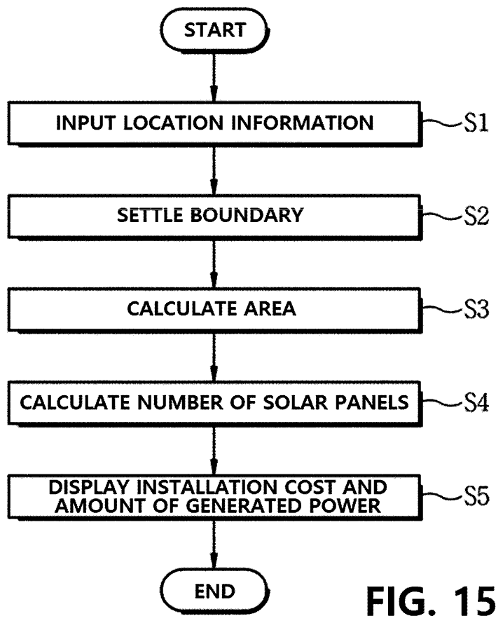

A simulation process related to installation of photovoltaic power generation equipment according to the present invention will be described in detail with reference to FIG. 15.

FIG. 15 is a flowchart of simulation method of photovoltaic device according to an exemplary embodiment of the present invention.

Referring to FIG. 15, the photovoltaic device simulator 100 may receive location information of a building in which solar panels will be installed through an input device and retrieve a satellite photo of a building corresponding to the received location information (S1).

In S1, the photovoltaic device simulator 100 may search an internal storage for a satellite photo of the building corresponding to the received location information and retrieve the satellite photo or may request and receive a satellite photo corresponding to the location information from an external device via a communication network.

Also, the photovoltaic device simulator 100 settles the boundary of a location in which solar panels can be installed in the satellite photo of the building (S2) and calculates an area specified by the settled boundary (S3).

In S2, the photovoltaic device simulator 100 may designate a point on the satellite photo of the building corresponding to the location information input in S1 and detect the boundary by expanding the area to pixels which have pixel values within a predetermined range from the pixel value of a pixel corresponding to the designated point on the basis of the location of the pixel corresponding to the designated point.

Also, in S2, the photovoltaic device simulator 100 may settle the boundary of the location in which solar panels can be installed by fusing the satellite photo of the building and a road view image of the building and determining a 3D shape of the building. At this time, the photovoltaic device simulator 100 may calculate a coordinate conversion matrix between the satellite photo of the building and the road view image of the building by matching feature points extracted from the satellite photo of the building and feature points extracted from the road view image of the building to each other such that the satellite photo of the building and the road view image of the building can be fused together. In this case, in S3, the photovoltaic device simulator 100 may calculate the area of a location in which solar panels can be installed according to the internal area of the boundary based on the determined 3D shape.

Then, the photovoltaic device simulator 100 calculates the number of solar panels that can be installed in the building by referring to information on a required installation area for solar panels according to the area calculated in S3 (S4).

In S4, the photovoltaic device simulator 100 may display the building on which solar panels are installed on the screen as a preview and thereby support a user in intuitively understanding the installation form.

Also, the photovoltaic device simulator 100 visually displays information on installation cost and information on the amount of generated power corresponding to the number of solar panels calculated in S4 on the screen such that a user can obtain the information (S5).

In S5, the photovoltaic device simulator 100 may calculate the amount of generated power corresponding to the area in which solar panels can be installed by referring to the amount of sunlight corresponding to the location of the building input in S1 and an irradiation angle for solar panels.

Also, in S5, when there is a shaded part in the satellite photo of the building or the road view image of the building, the photovoltaic device simulator 100 may calculate the amount of generated power by subtracting the amount of generated power corresponding to the shaded part from the total amount of generated power.

Also, in S5, the photovoltaic device simulator 100 may calculate expected earnings by referring to the transaction cost of an electric power exchange corresponding to the location information of the building and display the calculated expected earnings on the screen such that a user can obtain the expected earnings.

A photovoltaic power generation simulation method according to an exemplary embodiment of the present invention may be implemented in the form of a program that can be read by various computing means and recorded in a computer-readable recording medium.

Meanwhile, exemplary embodiments disclosed herein and in the drawings are specific examples to aid in understanding the present invention and are not intended to limit the scope of the present invention. Those of ordinary skill in the technical field to which the present invention pertains should appreciate that not only the exemplary embodiments disclosed herein but also other modifications can be made on the basis of the technical spirit of the present invention. Although specific terms are used herein and in the drawings, these are used in their general meaning to facilitate description of the present invention and aid in understanding the present invention and are not intended to limit the scope of the present invention.

### REFERENCE SIGNS LIST

10: simulation system

100: simulator

110: input unit

115: collection unit

120: determination unit

125: calculation unit

130: roof data module

135: communication unit

140: image analysis unit

145: geographical environment database

150: user environment database

155: simulation unit

160: photovoltaic sales support unit

165: display unit

170: control unit

175: power generation equipment information storage unit

180: satellite photo information storage unit

500: drone

600: user device

1. A photovoltaic device simulation method comprising:
receiving a land lot number of a region in which a photovoltaic device will be installed;
collecting real estate information, cadastral information, and a satellite photo of a numbered land lot associated with the received land lot number;
determining a land use of the numbered land lot and whether there is a building in the numbered land lot on the basis of the collected real estate information, cadastral information, and satellite photo; and
calculating an available installation area of a photovoltaic device in the numbered land lot according to results of the determination.

2. The photovoltaic device simulation method of claim 1, wherein the collecting of real estate information, cadastral information, and a satellite photo further comprises processing the satellite photo by detecting a boundary of an area corresponding to the land lot number on the basis of the collected real estate information, cadastral information, and satellite photo.

3. The photovoltaic device simulation method of claim 1, wherein the calculating of an available installation area comprises, when there is no building in the numbered land lot, calculating an available installation area of a photovoltaic device on the basis of an area, a land use, a slope, and geographical circumstances of the numbered land lot, and
the geographical circumstances include at least one of shadow, rainfall amount information, sunlight amount information, fine dust information, daylight hours information, temperature information, climate information, and wind speed information.

4. The photovoltaic device simulation method of claim 1, wherein the calculating of an available installation area comprises, when there is a building in the numbered land lot, calculating an available installation area of a photovoltaic device in a space other than the building and on a roof of the building on the basis of a building-to-land ratio of the numbered land lot.

5. The photovoltaic device simulation method of claim 4, further comprising storing roof data on roof shapes and installation-hindering factors in advance according to regions, building uses, and building shapes,
wherein the calculating of an available installation area comprises calculating an available installation area of a photovoltaic device by calculating a shape and an area of a roof of the building corresponding to the land lot number and a size of a hindering factor on the basis of the roof data.

6. The photovoltaic device simulation method of claim 4, wherein the collecting of real estate information, cadastral information, and a satellite photo comprises further collecting street views of a vicinity of the numbered land lot associated with the received land lot number, and
the calculating of an available installation area comprises extracting a roof image of the building from the collected satellite photo and street views, calculating a shape and an area of a roof and a size of a hindering factor through image accumulation and the extracted roof image, and calculating an available installation area of a photovoltaic device.

7. A photovoltaic device simulation system comprising:
an input unit configured to receive a land lot number of a region in which a photovoltaic device will be installed;
a collection unit configured to collect real estate information, cadastral information, and a satellite photo of a numbered land lot associated with the land lot number received through the input unit;
a determination unit configured to determine a land use of the numbered land lot and whether there is a building in the numbered land lot on the basis of the information collected through the collection unit; and
a calculation unit configured to calculate an available installation area of a photovoltaic device in the numbered land lot according to determination results of the determination unit.

8. The photovoltaic device simulation system of claim 7, wherein the collection unit processes the satellite photo by detecting a boundary of an area corresponding to the received land lot number in the satellite photo on the basis of the collected real estate information and cadastral information.

9. The photovoltaic device simulation system of claim 7, wherein when the determination unit determines that there is no building in the numbered land lot, the calculation unit calculates an available installation area of a photovoltaic device on the basis of an area, a land use, a slope, and geographical circumstances of the received numbered land lot, and
the geographical circumstances include at least one of shadow, rainfall amount information, sunlight amount information, fine dust information, daylight hours information, temperature information, climate information, and wind speed information.

10. The photovoltaic device simulation system of claim 7, wherein when there is a building in the numbered land lot, the collection unit calculates an available installation area of a photovoltaic device in a space other than the building and on a roof of the building on the basis of a building-to-land ratio of the numbered land lot.

11. The photovoltaic device simulation system of claim 10, further comprising a roof data module configured to store roof shapes and installation-hindering factors in advance according to regions, building uses, and building shapes, and
the calculation unit calculates an available installation area of a photovoltaic device by calculating a shape and an area of a roof of the building corresponding to the land lot number and a size of a hindering factor on the basis of information of the roof data module.

12. The photovoltaic device simulation system of claim 10, wherein the collection unit collects street views of a vicinity of the numbered land lot associated with the land lot number received through the input unit, and
the calculation unit extracts a roof image of the building from the satellite photo and street views collected by the collection unit, calculates a shape and an area of a roof and a size of a hindering factor through image accumulation and the extracted roof image, and calculates an available installation area of a photovoltaic device.

13. A photovoltaic device simulation program stored in a medium to execute the method of claim 1 in combination with a computer which is hardware.
